(19) United States
(12) Patent Application Publication
(10) Pub. No.: US 2025/0289246 A1
(43) Pub. Date: Sep. 18, 2025

(54) PRINTER AND CUTTING UNIT

(71) Applicant: BROTHER KOGYO KABUSHIKI KAISHA, Nagoya (JP)

(72) Inventor: Arisa NODA, Nagoya (JP)

(21) Appl. No.: 19/078,945

(22) Filed: Mar. 13, 2025

(30) Foreign Application Priority Data
Mar. 13, 2024 (JP) 2024-039200

(51) Int. Cl. B41J 11/70; B41J 2/32; B41J 11/04; B41J 29/13

(52) U.S. Cl. CPC B41J 11/70; B41J 2/32; B41J 11/04; B41J 29/13

(57) ABSTRACT

A printer includes a substrate, a first connector, and a first unit. The substrate is housed in a housing. The first connector is electrically connected to the substrate. The first unit is detachably attached to a mount portion. The first unit includes a first cutting blade, a first harness, and a second connector. The first cutting blade is configured to cut the medium printed. The first harness has one end connected to the first cutting blade. The second connector is configured to connect to the first connector and connects to another end of the first harness. With the first unit attached to the mount portion and the second connector connected to the first connector, the first cutting blade conducts to a ground of the substrate via the first harness, the second connector, and the first connector.

### REFERENCE TO RELATED APPLICATIONS

This application claims priority from Japanese Patent Application No. 2024-039200 filed on Mar. 13, 2024. The entire content of the priority application is incorporated herein by reference

### BACKGROUND ART

The present disclosure relates to a printer and a cutting unit.

A known printer is provided with a main body, a movable portion, a discharge port, a first cutting portion, and a second cutting portion. The main body accommodates rolled paper. The movable portion is provided so as to be able to open and close with respect to the main body. The discharge port is formed by the main body and the movable portion. The first cutting portion and the second cutting portion are each formed by a cutter blade. The first cutting portion is provided in the main body. The first cutting portion cuts the rolled paper discharged from the discharge port with the cutter blade. The second cutting portion is provided in the movable portion. The second cutting portion cuts the rolled paper discharged from the discharge port with the cutter blade.

### SUMMARY

Static electricity is generated on the cutting portion of the printer due to sliding between the cutter blade and the medium. As a means of removing the static electricity, it is conceivable to connect the cutter blade to a housing or metal frame of the printer. However, connecting the cutter blade to the metal frame of a housing by screws or soldering, for example, was time-consuming for the operator.

Various embodiments of the general principles described herein provide a printer and a cutting unit contribute to removing noise generated on a cutting blade, with a simple configuration.

Embodiments herein provide a printer includes a housing, a substrate, a first connector, a mount portion, and a first unit. The print unit is housed in the housing and is configured to perform printing on a medium. The substrate is housed in the housing. The first connector is electrically connected to the substrate. The mount portion is provided on the housing. The first unit is detachably attached to the mount portion. The first unit includes a first cutting blade, a first harness, and a second connector. The first cutting blade is configured to cut the medium printed by the print unit. The first harness has one end connected to the first cutting blade. The second connector is configured to connect to the first connector and connects to another end of the first harness. With the first unit attached to the mount portion and the second connector connected to the first connector, the first cutting blade conducts to a ground of the substrate via the first harness, the second connector, and the first connector.

In the above-described printer, when the first unit is attached to the printer, the operator connects the second connector of the first unit to the first connector. The operator then attaches the first unit to the mount portion. Therefore, the operator can attach the first unit to the printer by a simple operation. In addition, since the first cutting blade is grounded, the printer can remove noise such as static electricity generated on the first cutting blade. Therefore, the printer contributes to remove the noise generated on the cutting blade with a simple configuration.

Embodiments herein also provide a cutting unit attached to a mount portion of a printer including a print unit configured to perform printing on a medium, a substrate, and a main body connector electrically connected to the substrate. The cutting unit includes a cutting blade, a harness, and a connector. The cutting blade is configured to cut the medium printed by the print unit. The harness has one end connected to the cutting blade. The connector is connected to another end of the harness and is configured to connect to the main body connector. With the cutting unit attached to the mount portion and the connector connected to the main body connector, the cutting blade conducts to a ground of the substrate via the harness, the connector, and the main body connector.

This cutting unit obtains the same effect as the above printer.

### BRIEF DESCRIPTION OF DRAWINGS

FIG. 1 is a perspective view of a printer.

FIG. 2 is an exploded perspective view of the printer.

FIG. 3 is a cross-sectional view of the printer in the direction of the arrows at line A-A.

FIG. 4 is a cross-sectional view showing a region C shown in FIG. 3 expanded.

FIG. 5 is a perspective view of a first unit.

FIG. 6 is an exploded perspective view of the printer.

FIG. 7 is an exploded perspective view of the printer.

### DESCRIPTION

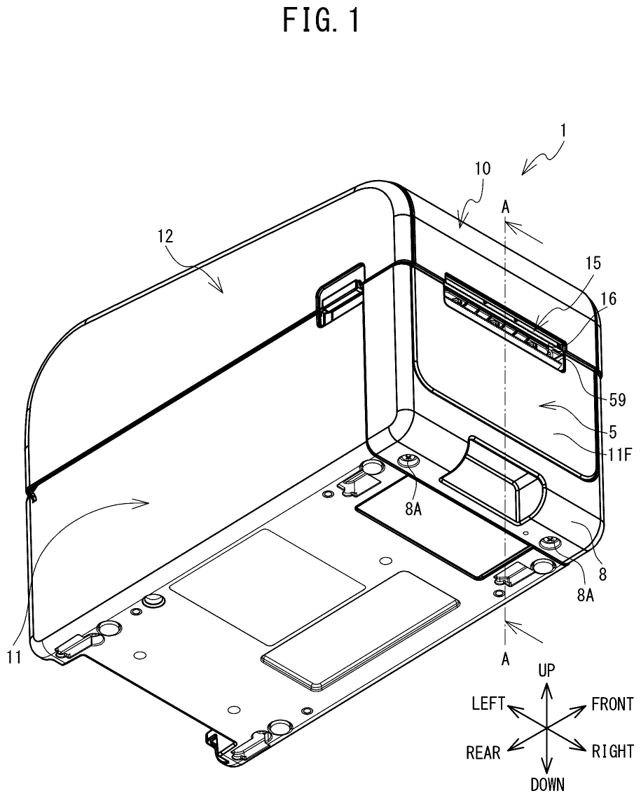

An embodiment of the present disclosure will be described with reference to the drawings. The drawings are used to illustrate technical features that the present disclosure may employ. In other words, the configurations and the like illustrated in the drawings are not intended to be limited thereto, but are merely illustrative examples. In the description of the present embodiment, an upper left direction, a lower right direction, an upper right direction, a lower left direction, an upward direction, and a downward direction in FIG. 1 are, respectively, a left direction, a right direction, a front direction, a rear direction, an upward direction, and a downward direction with respect to a printer 1.

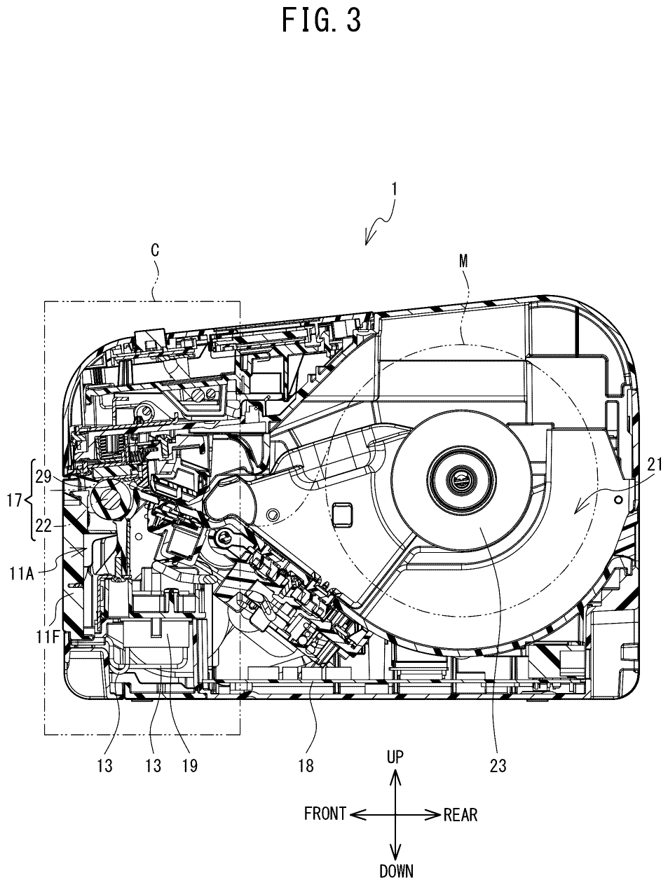

The printer 1 is configured to be able to print on a printable medium (hereinafter referred to as “medium M”) shown in FIG. 3. The medium M is, for example, a die-cut heat-sensitive label. The printer 1 performs printing on the medium M in cooperation with a print head 29 and a platen roller 22 (hereinafter, also collectively referred to as “print unit 17”) shown in FIG. 3. The medium M printed by the print unit 17 is discharged from a discharge portion 15 extending in the left-right direction.

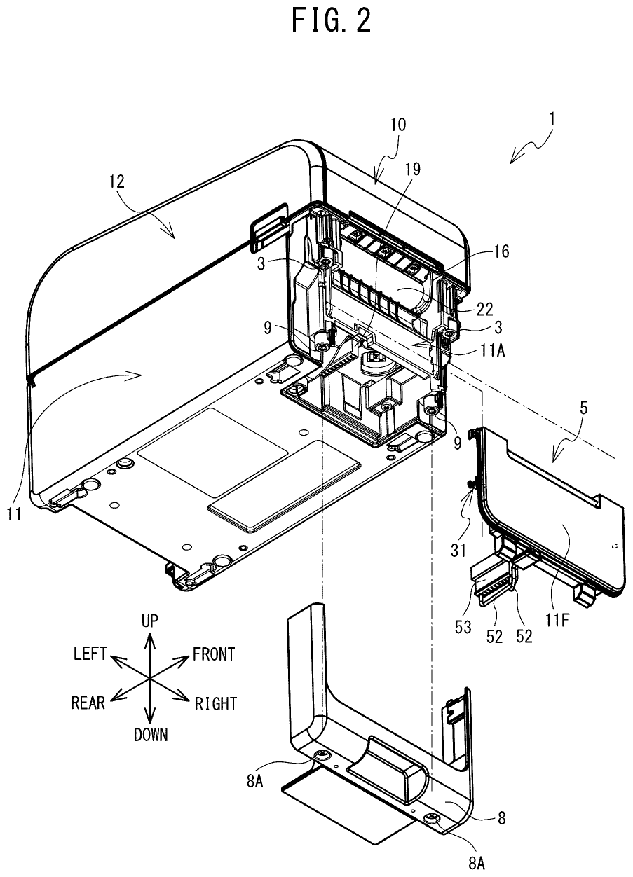

As shown in FIGS. 1 and 2, the printer 1 has a substantially cuboid shape that is long in the front-rear direction. The printer 1 is formed by a housing 10. The housing 10 includes a main body 11 and an cover 12. The main body 11 and the cover 12 are made of resin material, for example. The main body 11 has a substantially cuboid box shape and opens upwards. The main body 11 is opened and closed by the cover 12. The cover 12 will be described later.

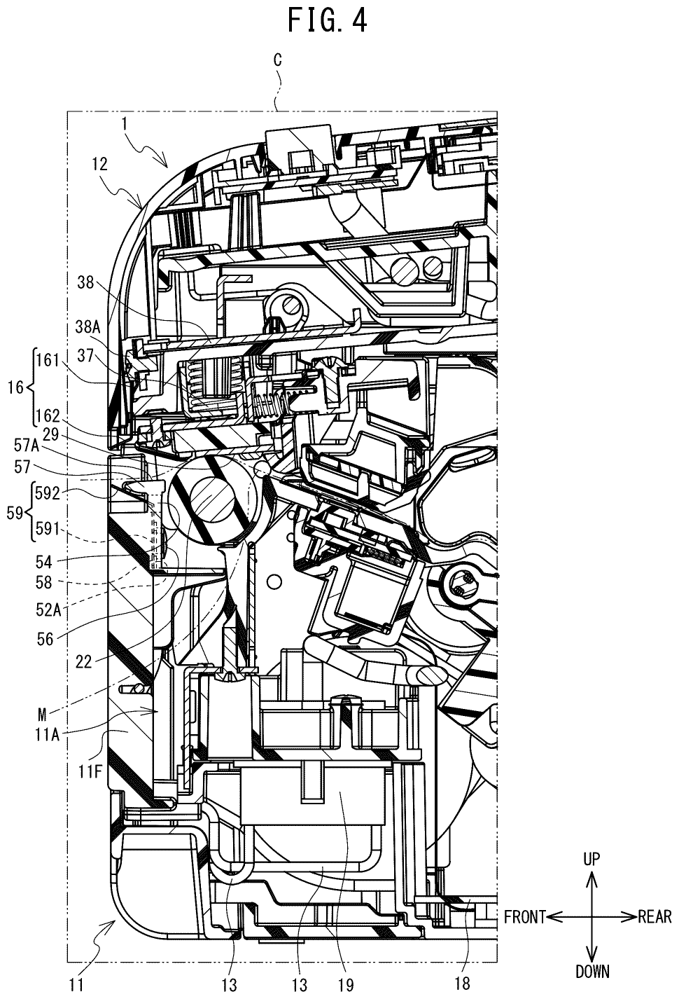

As shown in FIGS. 3 and 4, the main body 11 includes a substrate 18, a first connector 19, an accommodating portion 21, a roll support portion 23, the platen roller 22, and a mount portion 11A. The substrate 18 is accommodated inside the main body 11. More specifically, the substrate 18 is disposed on a bottom surface of the main body 11. The substrate 18 controls the operation of the printer 1. For example, the substrate 18 controls the print unit 17. The substrate 18 extends in the front-rear and left-right directions. The substrate 18 is long in the front-rear direction.

The first connector 19 is disposed on a front side of the substrate 18 and on the bottom surface of the main body 11. The first connector 19 is electrically connected to the substrate 18 via a harness 13. A plurality of pins (not shown in the drawings) arranged in a straight line are provided on the first connector 19. The plurality of pins are lined up in the front-rear direction. Of the plurality of pins, two pins, one at each end, are electrically connected to a ground of the substrate 18. The other pins are used for transmitting signals and the like from a control unit (not shown in the drawings). The other pins are used when second units 6 and 7, described later, are attached to the mount portion 11A of the printer 1.

The accommodating portion 21 is provided at the rear end portion from the central portion in the front-rear direction of the main body 11. The accommodating portion 21 is a space for accommodating the rolled medium M. The accommodating portion 21 is provided with the roll support portion 23. The roll support portion 23 rotatably supports the rolled medium M.

The platen roller 22 is provided at a front end portion of the main body 11 and on the rear side of the discharge portion 15. The platen roller 22 extends in the left-right direction along the discharge portion 15. The platen roller 22 is a cylindrical roller for transporting the medium M. The platen roller 22 rotates with the driving of a drive motor (not shown in the drawings).

The mount portion 11A is provided at the front end portion of the main body 11. The mount portion 11A is recessed toward the rear. Left and right screw holes 3 and 3 (refer to FIG. 2) are provided in a central portion of the mount portion 11A in the up-down direction. Left and right screw holes 9 and 9 (refer to FIG. 2) are provided at a lower end portion of the mount portion 11A. The platen roller 22 is exposed at an upper portion of the mount portion 11A. Further, the first connector 19 is exposed at a lower left portion of the mount portion 11A. A first unit 5 can be attached to the mount portion 11A. The first unit 5 is fixed to the screw holes 3 and 3 of the mount portion 11A with screws (not shown in the drawings). The first unit 5 will be described in detail later.

While the first unit 5 is attached to the mount portion 11A, a front cover 8 is attached from below. The front cover 8 is has a C-shape when viewed from the front. The first unit 5 engages with the C-shaped portion of the front cover 8. The front cover 8 is fixed with screws 8A and 8A to the screw holes 9 and 9 of the mount portion 11A.

As shown in FIGS. 3 and 4, the cover 12 is pivotably supported about a shaft (not shown in the drawings) extending in the left-right direction at an upper rear portion of the main body 11. The cover 12 has a box shape that opens downward. An upper surface of the cover 12 is provided with a display portion and an operation portion, not shown in the drawings. The display portion includes a liquid crystal display and displays various information. The operation portion is used for inputting various instructions to the printer 1.

The print head 29, a plate member 38, an urging member 37, and a second cutting blade 16 are housed in the front end portion of the cover 12. The print head 29 is provided in the front lower portion of the cover 12. The print head 29 has a plurality of heating elements lined up along the left-right direction. With the cover 12 closed, the print head 29 faces the platen roller 22 from above. By selectively heating the heating elements, the print head 29 prints an image of a character, a figure, or the like on the medium M.

The plate member 38 is provided at a front upper end of the cover 12. The plate member 38 has a rectangular shape that extends in the front-rear and left-right directions above the print head 29. The front end portion of the plate member 38 extends downward. The plate member 38 is electrically conductive.

The urging member 37 is disposed between the print head 29 and the plate member 38. The plate member 38 supports the urging member 37. The urging member 37 urges the print head 29 downward toward the platen roller 22.

The second cutting blade 16 is provided at a front end portion of the plate member 38. The second cutting blade 16 extends in the left-right direction. The second cutting blade 16 is electrically conductive. Because the plate member 38 is electrically conductive, the second cutting blade 16 conducts to the plate member 38. With the cover 12 closed, the second cutting blade 16 faces a first cutting blade 59, described later, from above.

The second cutting blade 16 includes a first portion 161 and a second portion 162. The first portion 161 has a plate shape that extends in the up-down and left-right directions. The first portion 161 is long in the left-right direction. The first portion 161 is fixed to the front end portion of the plate member 38 with a screw 38A. The second portion 162 extends forward and downward from a lower end of the first portion 161. A front end of the first portion 161 is able to cut the medium M.

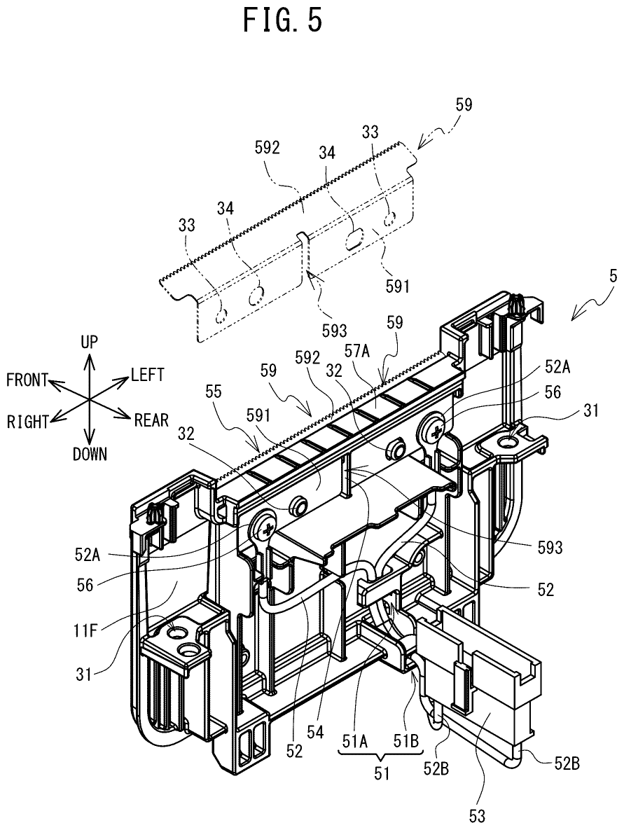

The first unit 5 will now be described with reference to FIG. 5. In FIG. 5, the configuration of the first cutting blade 59 before assembly is shown by a two-dot chain line. The first unit 5 is a cutting unit with which the operator cuts the medium M by manually pulling the medium M downward. The first unit 5 attaches to and detaches from the mount portion 11A.

The first unit 5 includes a cover housing 11F, the first cutting blade 59, first harnesses 52 and 52, and a second connector 53. The cover housing 11F has a rectangular shape that extends in the up-down and left-right directions. The cover housing 11F is long to the left and right. The cover housing 11F includes attachment portions 31 and 31, a recessed portion 55, a plate-shaped member 57, a support member 54, positioning portions 32 and 32, and a guide portion 51.

The attachment portions 31 and 31 are each provided in a central portion of the cover housing 11F in the up-down direction and at both end portions of the cover housing 11F in the left-right direction. The attachment portions 31 and 31 have holes that pass through in the up-down direction. The first unit 5 is fixed, through the holes in the attachment portions 31 and 31, to the screw holes 3 and 3 (refer to FIG. 2) in the mount portion 11A by screws (not shown in the drawing).

The recessed portion 55 is provided at the upper end portion of the cover housing 11F. The recessed portion 55 is recessed downward from the left end portion to the right end portion of the upper end portion of the cover housing 11F.

The portion of the rear surface of the cover housing 11F adjacent to the lower side of the recessed portion 55 is referred to as a fixing surface 58 (refer to FIG. 4). The fixing surface 58 is provided opposite a support surface 57A of the plate-shaped member 57 in the up-down direction. The fixing surface 58 has a rectangular shape that extends in the left-right direction. The first cutting blade 59, described later, is fixed to the fixing surface 58.

The plate-shaped member 57 is provided on the upper end portion of the cover housing 11F. More specifically, the plate-shaped member 57 is disposed above and away from the upper surface of the recessed portion 55. The plate-shaped member 57 extends in the left-right direction along the upper surface of the recessed portion 55. In other words, there is a gap between the plate-shaped member 57 and the recessed portion 55 in the left-right direction. The plate-shaped member 57 includes the support surface 57A. The support surface 57A supports the printed medium M by the print unit 17.

The support member 54 is provided in a central portion in the left-right direction of the fixing surface 58 of the cover housing 11F. The support member 54 has a plate-shape that protrudes rearward from the fixing surface 58 of the cover housing 11F. The support member 54 extends upward from the central portion of the fixing surface 58 and is connected to the central portion of the plate-shaped member 57 in the left-right direction. In other words, the support member 54 supports the central portion of the plate-shaped member 57 in the left-right direction from below.

The positioning portions 32 and 32 are provided on the fixing surface 58 of the cover housing 11F. The positioning portions 32 and 32 are arranged one to the left and one to the right of the support member 54. The positioning portions 32 and 32 protrude rearward from the fixing surface 58 of the cover housing 11F. The positioning portions 32 and 32 have a cylindrical shape.

The guide portion 51 is provided at a lower end portion of the rear surface of the cover housing 11F. The guide portion 51 guides the first harnesses 52 and 52, which will be described later. The guide portion 51 includes a first guide portion 51A and a second guide portion 51B. The first guide portion 51A has a hole that passes through in the up-down direction. The second guide portion 51B is disposed below the first guide portion 51A. The second guide portion 51B has a hole that passes through in the front-rear direction.

The first cutting blade 59 is inserted through the gap between the recessed portion 55 and the plate-shaped member 57. The first cutting blade 59 is disposed below the support surface 57A of the plate-shaped member 57. Therefore, the first cutting blade 59 is disposed below the medium M supported by the support surface 57A. The first cutting blade 59 cuts the medium M supported by the support surface 57A. The first cutting blade 59 is electrically conductive.

The first cutting blade 59 includes a first portion 591 and a second portion 592. The first portion 591 is disposed on the fixing surface 58 (refer to FIG. 4). The first portion 591 has a plate-shape that extends in the left-right direction. The first portion 591 extends in the left-right direction. A slit 593 extending in the up-down direction is provided in a central portion of the first portion 591 in the left-right direction. The first portion 591 includes positioning portions 34 and 34 to the left end and right end of the slit 593 in the left-right direction. The first portion 591 is provided with holes 33 and 33 one to the left and one to the right of the positioning portions 34 and 34. The hole 33 to the right is provided in a right end portion of the first portion 591. The hole 33 to the left is provided in a left end portion of the first portion 591.

The second portion 592 has plate-shape that extends in the left-right direction. The second portion 592 extends from an upper end of the first portion 591 toward the front and upward. A tip end portion of the second portion 592 is disposed lower than the support surface 57A of the plate-shaped member 57 in the up-down direction. The second portion 592 extends toward the medium M supported by the support surface 57A located above. The end portion of the second portion 592 can cut the printed medium M.

The support member 54 is inserted into the slit 593 of the first portion 591. The positioning portions 34 and 34 of the first portion 591 are inserted through the positioning portions 32 and 32 of the cover housing 11F, respectively. The first portion 591 is positioned in the left-right direction by the support member 54. The position of the first portion 591 is determined, in the up-down and left-right directions, by the positioning portions 34 and 34.

Two of the first harnesses 52 and 52 are provided. One end 52A and 52A of each of the two first harnesses 52 and 52 has an annular shape. The one end 52A of the first harness 52 on the right is fixed by a screw 56 to the fixing surface 58 through the hole 33 on the front side of the first portion 591. The one end 52A of the first harness 52 on the left conducts to the right end of the second portion 592. The one end 52A of the first harness 52 on the left is fixed by a screw 56 to the fixing surface 58 (refer to FIG. 4) through the hole 33 on the left side of the first portion 591. Therefore, the first cutting blade 59 is fixed to the fixing surface 58 (refer to FIG. 4).

The two first harnesses 52 and 52 are guided to the first guide portion 51A and the second guide portion 51B of the guide portion 51 and bundled together thereby. The other ends 52B and 52B of the two first harnesses 52 and 52 are routed toward the second connector 53.

The second connector 53 includes a plurality of pins lined up in a straight line. The other end 52B of the right first harness 52 is connected to the rear end of the second connector 53. The other end 52B of the left first harness 52 is connected to the front end of the second connector 53. In other words, the other ends 52B and 52B of the two first harnesses 52 and 52 are connected to pins, respectively, at both ends of the second connector 53.

The second connector 53 can be connected to the first connector 19. When the second connector 53 is connected to the first connector 19, the plurality of pins of the second connector 53 line up in the front-rear direction. The pins (not shown in the drawings) at both ends of the second connector 53 are connected to the pins (not shown in the drawings) at both ends of the first connector 19. Of the plurality of pins of the second connector 53, the pins at both ends that are disposed on the outermost ends are electrically connected to the ground of the substrate 18.

Accordingly, while the first unit 5 is attached to the mount portion 11A and the second connector 53 is connected to the first connector 19, the first cutting blade 59 conducts to the ground of the substrate 18 through the first harnesses 52 and 52, the second connector 53, and the first connector 19.

Operation during printing of the printer 1 will now be described. The operator opens the cover 12 of the printer 1. The operator loads the medium M onto the roll support portion 23 of the accommodating portion 21. The operator pulls out the medium M and arranges the end of the medium M on the upper side of the platen roller 22. The operator then closes the cover 12. At this time, the medium M is sandwiched between the print head 29 and the platen roller 22. The operator operates the operation unit (not shown in the drawings) to instruct printing on the medium M.

The control unit (not shown in the drawings) of the printer 1 drives the platen roller 22. The platen roller 22 transports the medium M. The rolled medium M is pulled forward by the medium M being transported. The control unit drives the print head 29 to perform printing on the medium M. In other words, printing by the print unit 17 is performed.

When printing is completed, the medium M is guided toward the discharge portion 15. The medium M is supported on the support surface 57A. Further, the medium M is disposed between the first cutting blade 59 and the second cutting blade 16. The operator picks up the printed medium M and cuts the medium M with the first cutting blade 59 or the second cutting blade 16. For example, when the printer 1 is placed at a low position, the second cutting blade 16 may be used. Also, for example, the first cutting blade 59 may be used when the printer 1 is placed at a high position.

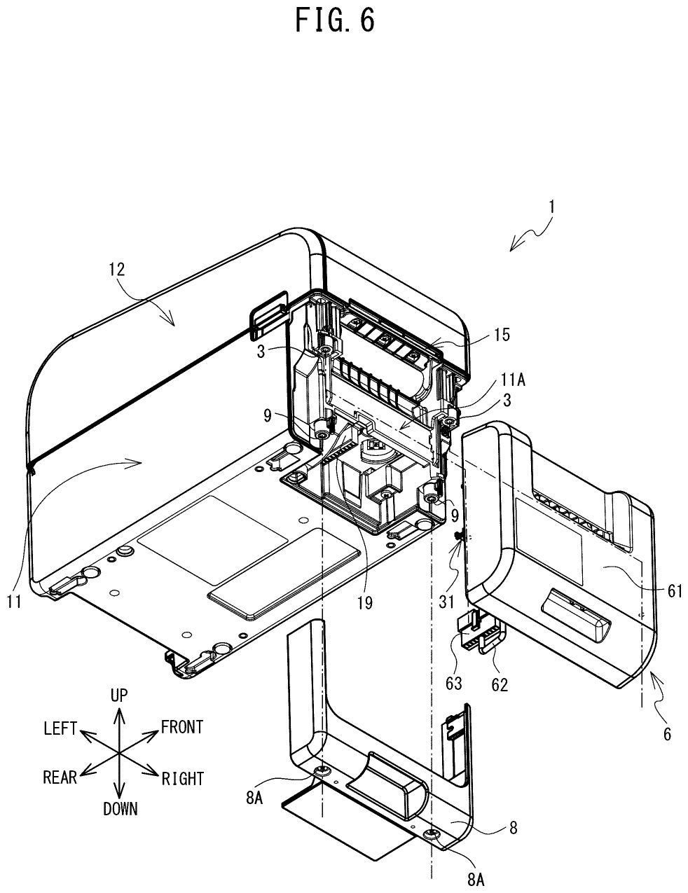

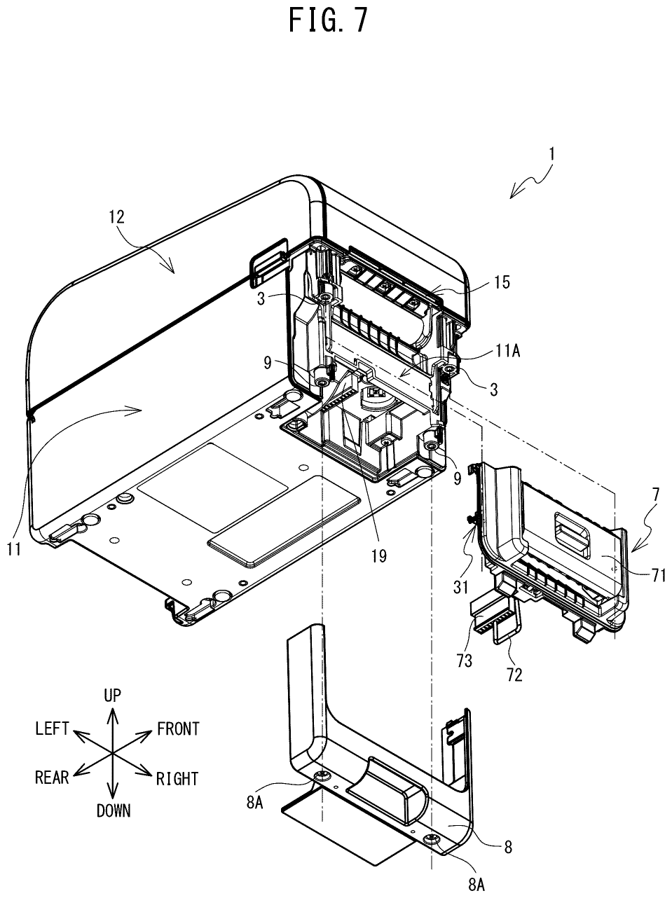

The second units 6 and 7 will now be described with reference to FIGS. 6 and 7. In addition to the first unit 5, the second units 6 and 7 can be selectively attached to the mount portion 11A of the printer 1. The second unit 6 shown in FIG. 6 is, for example, a cutting unit for automatically cutting the medium M.

The second unit 6 includes a unit housing 61, a drive mechanism (not shown in the drawings), a second harness 62, and a third connector 63. The unit housing 61 has a rectangular shape when viewed from the front. The unit housing 61 is fixed to the screw holes 3 and 3 of the mount portion 11A by screws (not shown in the drawings) through the attachment portions 31 and 31 in the same way as the first unit 5.

A drive mechanism is provided on the rear surface of the unit housing 61. The drive mechanism is formed by, for example, a motor, a gear, a cutting blade, and the like. The drive mechanism is driven based on a predetermined electrical signal. One end of the second harness 62 is electrically connected to the drive mechanism. The other end of the second harness 62 is connected to the third connector 63. The third connector 63 is connectable with the first connector 19. The third connector 63 has pins at both ends of the plurality of pins connected to the ground of the substrate 18. The third connector 63 is capable of transmitting and receiving electrical signals from pins other than those at both end portions, from among the plurality of pins.

An electrical signal for driving the motor is transmitted from the substrate 18. The electrical signal is transmitted to the drive mechanism via the first connector 19, the third connector 63, and the second harness 62. When the motor of the drive mechanism is driven, the cutting blade automatically cuts the medium M.

The second unit 7 will be described with reference to FIG. 7. The second unit 7 is a peeling unit for automatically peeling a label from, for example, a backing sheet of the printed medium M. The second unit 7 includes a unit housing 71, a drive mechanism (not shown in the drawings), a second harness 72, and a third connector 73. The unit housing 71 has a rectangular shape when viewed from the front. The attachment of the unit housing 71 to the mount portion 11A is the same as in the case of the second unit 6.

The drive mechanism (not shown in the drawings) is provided on the rear surface of the unit housing 71. The drive mechanism is, for example, a peeling mechanism. The peeling mechanism is driven by a predetermined electrical signal. The connection and function of the second harness 72 and the third connector 73 are the same as in the case of the second unit 6. Therefore, a detailed description thereof will be omitted.

An electrical signal for driving the peeling mechanism (not shown in the drawings) is transmitted from the substrate 18. The electrical signal is transmitted to the peeling mechanism via the first connector 19, the third connector 73, and the second harness 72. Thus, the label is automatically peeled off of the backing sheet of the medium M.

An operation to change the first unit 5 and the second units 6 and 7 with respect to the mount portion 11A will now be described. Hereinafter, a case of changing from a state in which the first unit 5 is attached to the mount portion 11A to a state in which the second unit 6 is attached to the mount portion 11A will be described as an example.

The operator removes the two screws 8A from the screw holes 9 and 9. The operator then pulls the front cover 8 downward and removes the screws (not shown in the drawings) from the screw holes 3 and 3 of the mount portion 11A. The operator removes the first unit 5 from the mount portion 11A, and removes the second connector 53 from the first connector 19. With this, removal of the first unit 5 from the mount portion 11A is complete.

Next, the operator attaches the third connector 63 of the second unit 6 to the first connector 19, and overlays the attachment portions 31 and 31 of the second unit 6 with the screw holes 3 and 3 of the mount portion 11A. In this state, the operator attaches the screws (not shown in the drawings) to the screw holes 3 and 3. The operator then attaches the front cover 8 to the main body 11 from below, and attaches the screws 8A and 8A to the screw holes 9 and 9 of the mount portion 11A. With this, attachment of the second unit 6 to the mount portion 11A is complete.

Note that the operator may change from the first unit 5 to the second unit 7 in the same way as that described above. Further, the operator can also change from the second units 6 and 7 to the first unit 5 in the same way. The operator can also change from the second unit 6 to the second unit 7 in the same way.

As described above, the first unit 5 is detachably attached to the mount portion 11A. The first unit 5 includes the first cutting blade 59, the first harnesses 52 and 52, and the second connector 53. The first cutting blade 59 cuts the medium M printed by the print unit 17. The first harnesses 52 and 52 are connected to the first cutting blade 59 by the one ends 52A and 52A. The second connector 53 can be connected to the first connector 19 and connects to the other ends 52B of the first harnesses 52 and 52. While the first unit 5 is attached to the mount portion 11A and the second connector 53 is connected to the first connector 19, the first cutting blade 59 conducts to the ground of the substrate 18 through the first harnesses 52 and 52, the second connector 53, and the first connector 19.

In the above-described printer 1, when attaching the first unit 5 to the printer 1, the operator connects the second connector 53 of the first unit 5 to the first connector 19. The operator then attaches the first unit 5 to the mount portion 11A. Therefore, the printer contributes to the operator to attach the first unit 5 to the printer 1 by a simple operation. Further, because the first cutting blade 59 conducts to the ground, the printer 1 contributes to removing noise such as static electricity generated on the first cutting blade 59. Therefore, the printer 1 contributes to removing noise generated on the cutting blade with a simple configuration.

The first unit 5 and the second units 6 and 7 can be selectively attached to the mount portion 11A. For example, the second unit 6 includes the drive mechanism, the second harness 62, and the third connector 63. The drive mechanism is driven based on the predetermined electrical signal. The second harness 62 is electrically connected to the drive mechanism at one end. The third connector 63 is connected to the other end of the second harness 62 and can be connected to the first connector 19. The operator removes the first unit 5 from the mount portion 11A, and disconnects the second connector 53 from the first connector 19. With this, the first unit 5 is removed from the printer 1. The operator then connects the third connector 63 to the first connector 19, and attaches the second unit 6 to the mount portion 11A. With this, the second unit 6 is attached to the printer 1. The first unit 5 and the second unit 6 are easy to assemble because the connector of each is connected to the common first connector 19 of the printer 1. Note that the same applies also when changing from the second unit 6 to the first unit 5. Therefore, the operator can easily change between the first unit 5 and the second unit 6. Further, the ground used in the control of the second unit 6 is commonly utilized to connect the first cutting blade 59 of the first unit 5 to the ground. Therefore, the printer 1 contributes to not changing the configuration on the printer 1 side even when the first unit 5 is used.

The housing 10 includes the main body 11 and the cover 12. The main body 11 is provided with the mount portion 11A and opens upward. The cover 12 opens and closes the opening of the main body 11. The cover 12 is provided with the second cutting blade 16. The second cutting blade 16 faces the first cutting blade 59 from above with the cover 12 closed. The operator can cut the medium M with the first cutting blade 59 by pulling the printed medium M downward. Further, printer 1 contributes to the operator to cut the medium M with the second cutting blade 16 by pulling the printed medium M upwards.

The print unit 17 includes the platen roller 22 and the print head 29. The platen roller 22 transports the medium M. The print head 29 performs printing on the medium M. The cover 12 includes the urging member 37 and the plate member 38. The urging member 37 urges the print head 29 downward toward the platen roller 22. The plate member 38 is electrically conductive and supports the urging member 37. The second cutting blade 16 is electrically connected to the plate member 38. The printer 1 also contributes to removing static electricity from the second cutting blade 16 through the plate member 38.

Two of the first harnesses 52 and 52 are provided. By providing two of the first harnesses 52 and 52, the printer 1 contributes to increasing the ability to remove static electricity compared to when only one harness is provided.

The second connector 53 is provided with the plurality of pins arranged in a straight line. Of the plurality of pins, the pins at both ends that are disposed at the outermost ends are conducted to the ground. The two first harnesses 52 and 52 are provided. The other ends 52B and 52B of the two first harnesses 52 and 52 are each connected to the pins at both ends of the second connector 53. The printer 1 contributes to efficiently removing static electricity generated on the first cutting blade 59. The printer 1 contributes to inhibiting the noise, from the pins connected to the ground, from being picked up by the other pins when static electricity flows to the ground.

The first unit 5 includes the plate-shaped member 57. The plate-shaped member 57 includes the support surface 57A that supports the medium M printed at the print unit 17. The first cutting blade 59 is disposed below the medium M supported by the support surface 57A. The first cutting blade 59 includes the first portion 591 and the second portion 592. The first portion 591 has a plate shape. The first portion 591 is disposed on the fixing surface 58 opposite the support surface 57A of the plate-shaped member 57. The first cutting blade 59 extends in the left-right direction. The second portion 592 also has a plate shape. The second portion 592 extends upward from the front end portion of the first portion 591 toward the medium M supported by the support surface 57A positioned above. The second portion 592 cuts the medium M. The two first harnesses 52 and 52 are provided. The one end 52A of the right first harness 52 is fixed to the fixing surface 58 via the right end portion of the first portion 591 by the screw 56. The one end 52A of the first harness 52 on the left side is fixed by the screw 56 to the fixing surface 58 via the left end portion of the first portion 591 in the left-right direction. The first cutting blade 59 is fixed at two end portions in the left-right direction. Therefore, the printer 1 contributes to stability of the position of the first cutting blade 59 in the up-down direction.

The first unit 5 includes the support member 54. The support member 54 extends in the up-down direction and supports the central portion of the plate-shaped member 57 in the left-right direction from below. The first portion 591 includes the slit 593 in the central portion in the left-right direction. With the support member 54 inserted into the slit 593, the first portion 591 is fixed to the fixing surface 58. The support member 54 is inserted into the slit 593 of the first cutting blade 59. Therefore, the printer 1 contributes to stability of the position of the first cutting blade 59 in the left-right direction.

In the above description, the first unit 5 is an example of the “cutting unit” of the present disclosure. The first connector 19 is an example of the “main body connector” of the present disclosure. The first cutting blade 59 is an example of the “cutting blade” of the present disclosure. The first harnesses 52 and 52 are each an example of the “harness” of the present disclosure. The second connector 53 is an example of the “connector” of the present disclosure. The front direction is an example of the “transport direction” of the present disclosure. The left-right direction is an example of the “extending direction” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The present disclosure is not limited to the above-described embodiments and the like; various further modifications are possible. The features disclosed in the above-described embodiments and modified examples can be combined so long as they are not contradictory. The printer 1 is a thermal-type printer, but the disclosure is not limited to this. The printer 1 may alternatively employ an inkjet system. The printer 1 is powered by a battery, but the disclosure is not limited to this. An AC adapter may be used as an external power supply.

In the above-described embodiment, the housing 10 includes the main body 11 and the cover 12, but the disclosure is not limited to this. The housing 10 does not have to open and close by the cover 12. For example, the printer 1 may be a so-called fanfold-type printer that transports the medium M to the printer 1 from the outside.

In the above-described embodiment, in addition to the first unit 5, the second units 6 and 7 can be attached to the mount portion 11A, but the disclosure is not limited to this. For example, in addition to the second units 6 and 7, a unit having another function may be attached to the mount portion 11A. In this case, a connector of the unit having another function need only be compatible with the third connectors 63 and 73 of the second units 6 and 7.

In the above-described embodiment, two of the first harnesses 52 and 52 are provided, but the disclosure is not limited to this. For example, one or three or more of the first harnesses 52 may be provided. The number of the first harnesses 52 may be selected as appropriate. The greater the number of the first harnesses 52, the greater the effect of removing static electricity.

In the above-described embodiment, the pins connected to the ground of the substrate 18 are the pins at both ends, but the disclosure is not limited to this. The pins to be connected to the ground may be selected as appropriate.

In the above-described embodiment, the plurality of pins of the connector are lined up in a row, but the disclosure is not limited to this. For example, the pins may be arranged in a plurality of rows.

In the above-described embodiment, the plate-shaped member 57 is supported by the support member 54, but the disclosure is not limited to this. For example, not just one but a plurality of the support member 54 may be provided. The slit 593 of the first cutting blade 59 may be provided accordingly.

What is claimed is:

1. A printer comprising:
a housing;
a print unit housed in the housing and configured to perform printing on a medium;
a substrate housed in the housing;
a first connector electrically connected to the substrate;
a mount portion provided on the housing; and
a first unit detachably attached to the mount portion,
wherein the first unit includes:
a first cutting blade configured to cut the medium printed by the print unit;
a first harness having one end connected to the first cutting blade; and
a second connector configured to connect to the first connector and connects to another end of the first harness, and
wherein with the first unit attached to the mount portion and the second connector connected to the first connector, the first cutting blade conducts to a ground of the substrate via the first harness, the second connector, and the first connector.

2. The printer according to claim 1, wherein
the first unit and a second unit are configured to be selectively attached to the mount portion, and
the second unit includes:
a drive mechanism driven by a predetermined electrical signal;
a second harness having one end connected electrically to the drive mechanism; and
a third connector connected to another end of the second harness and configured to connect to the first connector.

3. The printer according to claim 1, wherein
the housing includes:
a main body provided with the mount portion and opens upward; and
a cover configured to open and close an opening of the main body, and
the cover is provided with a second cutting blade facing the first cutting blade from above in a state in which the cover is closed.

4. The printer according to claim 3, wherein
the print unit includes:
a platen roller configured to transport the medium; and
a print head configured to perform printing on the medium, the cover includes:
an urging member configured to urge the print head downward toward the platen roller; and
an plate member having electrical conductivity and configured to support the urging member, and
the second cutting blade is electrically connected to the plate member.

5. The printer according to claim 1, wherein
the first harness is provided plurality.

6. The printer according to claim 5, wherein
a plurality of pins lined up in a straight line are provided on the second connector,
of the plurality of pins, pins on both ends disposed on outermost ends conduct to the ground,
two of the first harnesses are provided, and
the other ends of the two first harnesses are connected to the pins on both of the ends of the second connector, respectively.

7. The printer according to claim 5, wherein
the first unit includes:
a plate-shaped member provided with a support surface, the support surface is configured to support the medium printed by the print unit,
the first cutting blade is disposed below the medium supported by the support surface,
the first cutting blade includes:
a first portion disposed on a fixing surface opposite the support surface of the plate-shaped member, and extending in an extending direction orthogonal to a transport direction of the medium, the first portion being plate-shaped; and
a second portion configured to cut the medium and extends upward from an end portion on a downstream side in the transport direction of the first portion, toward the medium supported by the support surface positioned above,
two of the first harnesses are provided,
one end of one of the first harnesses is fixed by a screw to the fixing surface via one end portion of the first portion in the extending direction, and
one end of the other of the first harnesses is fixed by a screw to the fixing surface via another end portion of the first portion in the extending direction.

8. The printer according to claim 7, wherein
the first unit includes;
a support member extending in an up-down direction and configured to support, from below, a central portion of the plate-shaped member in the extending direction,
the first portion includes;
a slit in a central portion in the extending direction, and
the first portion is fixed to the fixing surface in a state in which the support member inserted into the slit.

9. A cutting unit attached to a mount portion of a printer including a print unit configured to perform printing on a medium, a substrate, and a main body connector electrically connected to the substrate, the cutting unit comprising:
a cutting blade configured to cut the medium printed by the print unit;
a harness having one end and connected to the cutting blade; and
a connector connected to another end of the harness and configured to connect to the main body connector,
wherein with the cutting unit attached to the mount portion and the connector connected to the main body connector, the cutting blade conducts to a ground of the substrate via the harness, the connector, and the main body connector.
